(19) United States
(12) Patent Application Publication
(10) Pub. No.: US 2026/0203141 A1
(43) Pub. Date: Jul. 16, 2026

(54) MESSAGE APPLICATION PROGRAMMING INTERFACE

(71) Applicant: Schlumberger Technology Corporation, Sugar Land, TX (US)

(72) Inventors: Jon-Terje Lilleby, Lysake (NO); Dominic Vincent Perroni, Sugar Land, TX (US)

(21) Appl. No.: 19/022,737

(22) Filed: Jan. 15, 2025

(51) Int. Cl. G06F 9/54; G06F 21/30

(52) U.S. Cl. CPC G06F 9/541; G06F 21/30

(57) ABSTRACT

The present disclosure relates to systems and methods for using an application programming interface to connect with a data engine. The application programming interface uses a messaging software development kit that receives a request for the data engine and converts the request into a message in a format compatible with the data engine. The messaging software development kit facilitates communication with the data engine from the application programming interface.

### BACKGROUND OF THE DISCLOSURE

Wellbores are commonly drilled from a surface location or seabed for various exploration and extraction activities. These wellbores are used to access and extract fluid resources like liquid and gaseous hydrocarbons from subterranean formations. The construction of wellbores involves the use of earth-boring equipment such as drill bits for initial drilling and reamers for enlarging the wellbore diameters.

Simulator models in the oil and gas industry help maximize production potential from subterranean formations. Simulations help investigate transient behavior in pipelines and wellbores. The simulators provide a prediction of operational conditions and system dynamics, such as, time-varying changes in flow rates, fluid compositions, temperature, solids depositions, and operational changes. The simulators help assess the operational risk.

### SUMMARY

This summary is provided to introduce a selection of concepts that are further described in the detailed description. This summary is not intended to identify key or essential features of the claimed subject matter, nor is it intended to be used as an aid in limiting the scope of the claimed subject matter.

Some implementations relate to a method. The method includes receiving, at an application programming interface, a request for a simulation created by a data engine. The method includes transforming, using a messaging layer in communication with the application programming interface, the request into a message in a format compatible with the data engine. The method includes communicating, using transmission control protocols, the message to the data engine. The method includes receiving, from the data engine, a response to the message. The method includes transforming, using the messaging layer, the response to a format compatible with the application programming interface. The method includes presenting, using the application programming interface, the response with the simulation.

Some implementations relate to a device. The device includes a memory to store data and instructions; and a processor operable to communicate with the memory, wherein the processor is operable to: receive, at an application programming interface, a request for a simulation created by a data engine; transform, using a messaging layer in communication with the application programming interface, the request into a message in a format compatible with the data engine; communicate, using transmission control protocols, the message to the data engine; receive, from the data engine, a response to the message; transform, using the messaging layer, the response to a format compatible with the application programming interface; and present, using the application programming interface, the response with the simulation.

Some implementations relate to a computer-readable storage medium including instructions that, when executed by a processor, cause the processor to: receive, at an application programming interface, a request for a simulation created by a data engine; transform, using a messaging layer in communication with the application programming interface, the request into a message in a format compatible with the data engine; communicate, using transmission control protocols, the message to the data engine; receive, from the data engine, a response to the message; transform, using the messaging layer, the response to a format compatible with the application programming interface; and present, using the application programming interface, the response with the simulation.

Additional features and aspects of implementations of the disclosure will be set forth herein, and in part will be obvious from the description, or may be learned by the practice of such implementations. The features and advantages of such implementations may be realized and obtained by means of the instruments and combinations particularly pointed out in the appended claims. These and other features will become more fully apparent from the following description and appended claims, or may be learned by the practice of such implementations as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is an example of a downhole system in accordance with implementations of the present disclosure.

FIG. 2 illustrates an example environment for using an application programming interface enabling communications with a data engine in accordance with implementations of the present disclosure.

FIG. 3 illustrates an example messaging software development kit (SDK) in accordance with implementations of the present disclosure.

FIG. 4 illustrates an example method for communicating with a data engine in accordance with implementations of the present disclosure.

FIG. 5 illustrates components that may be included within a computer system.

### DETAILED DESCRIPTION

This disclosure generally relates to systems and methods for providing an application programming interface (API) enabling communications with a data engine in the oil and gas industry. The data engine provides a simulator. Simulator models in the oil and gas industry help maximize production potential from subterranean formations. Simulations help investigate transient behavior in pipelines and wellbores. The simulators provide a prediction of operational conditions and system dynamics, such as, time-varying changes in flow rates, fluid compositions, temperature, solids depositions, and operational changes. The simulators help assess the operational risk.

Existing simulators have limited communication capabilities with other applications. For example, existing simulators communicate with applications in specific programming languages or using a specific technology protocol (e.g., open platform communication (OPC)). OPC is used in existing simulators to connect simulators to a data engine and extract field data for use with the simulators. OPC is slower as compared to other technology protocols, such as, ZeroMQ technology.

The systems and methods of the present disclosure provide an application programming interface (API) that supports applications and other simulators to connect with a data engine. In some implementations, the data engine is the OLGA engine of Schlumberger Technologies.

In some implementations, the data engine provides a simulator that provides a prediction of operational conditions and system dynamics, such as, time-varying changes in flow rates, fluid compositions, temperature, solids depositions, and operational changes using the data in the data engine. In some implementations, the data engine performs an interactive simulation with field data. For example, a process simulator is connected to the data engine, or the data engine is connected to real time field data. In some implementations, the data engine uses ZeroMQ technology connecting the data engine to other simulators. As will be discussed in further detail below, the present disclosure includes a number of practical applications having features described herein that provide benefits and/or solve problems associated with using the API to communicate with the data engine.

Some example benefits are discussed herein in connection with various features and functionalities provided by the API on one or more computing devices. It will be appreciated that benefits explicitly discussed in connection with one or more implementations described herein are provided by way of example and are not intended to be an exhaustive list of all possible benefits of the well intervention tool. For example, one benefit includes connecting a process simulator to the data engine using the API. Another example benefit includes connecting real time field data to the data engine using the API. Another example benefit includes allowing applications in different programming languages (e.g., PYTHON, C, C++, C#) to connect to the data engine using the API. Another example benefit includes running an interactive simulation with the data engine using the API. Another example benefit includes running a steady state simulation with the data engine using the API.

In some implementations, the API includes a messaging component that communicates with the data engine (e.g., the OLGA engine) and applications. The messaging component enables the applications to communicate with the data engine. In some implementations, the applications are available in different programming languages and the messaging component enables the different programming languages to communicate with the data engine.

One of the technical advantages of the systems and methods of the present disclosure is fast and secure message exchanges with the data engine. For example, the systems and methods provide fast and secure message exchanges with the OLGA engine. Another technical advantage of the systems and methods of the present disclosure is enabling applications in different programming languages to communicate with the data engine. For example, the systems and methods enable applications in different programming languages to communicate with the OLGA engine. In some implementations, the systems and methods can execute on different operating systems. For example, the systems and methods operate the OLGA engine on LINUX. Existing solutions are not usable on LINUX systems.

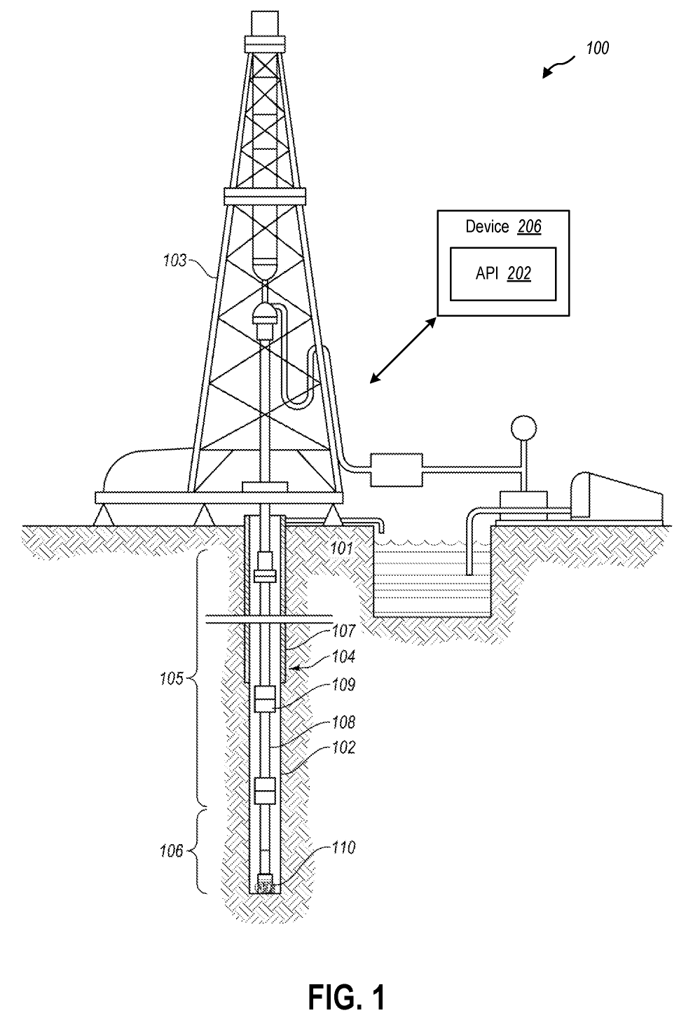

Additional details will now be provided regarding systems described herein in relation to illustrative figures portraying example implementations. For example, FIG. 1 shows one example of a downhole system 100 for drilling an earth formation 101 to form a wellbore 102. The downhole system 100 includes a drill rig 103 used to turn a drilling tool assembly 104 which extends downward into the wellbore 102. The drilling tool assembly 104 may include a drill string 105, a bottomhole assembly (“BHA”) 106, and a bit 110, attached to the downhole end of the drill string 105.

The drill string 105 may include several joints of drill pipe 108 connected end-to-end through tool joints 109. The drill string 105 transmits drilling fluid through a central bore and transmits rotational power from the drill rig 103 to the BHA 106. In some implementations, the drill string 105 further includes additional downhole drilling tools and/or components such as subs, pup joints, etc. The drill pipe 108 provides a hydraulic passage through which drilling fluid is pumped from the surface. The drilling fluid discharges through selected-size nozzles, jets, or other orifices in the bit 110 for the purposes of cooling the bit 110 and cutting structures thereon, and for lifting cuttings out of the wellbore 102 as it is being drilled.

The BHA 106 may include the bit 110, other downhole drilling tools, or other components. An example BHA 106 may include additional or other downhole drilling tools or components (e.g., coupled between the drill string 105 and the bit 110). Examples of additional BHA components include drill collars, stabilizers, measurement-while-drilling (“MWD”) tools, logging-while-drilling (“LWD”) tools, downhole motors, underreamers, section mills, hydraulic disconnects, jars, vibration or dampening tools, other components, or combinations of the foregoing.

In general, the downhole system 100 may include other downhole drilling tools, components, and accessories such as special valves (e.g., kelly cocks, blowout preventers, and safety valves). Additional components included in the downhole system 100 may be considered a part of the drilling tool assembly 104, the drill string 105, or a part of the BHA 106, depending on their locations in the downhole system 100.

The bit 110 in the BHA 106 may be any type of bit suitable for degrading downhole materials. For instance, the bit 110 may be a drill bit suitable for drilling the earth formation 101. Example types of drill bits used for drilling earth formations are fixed cutter or drag bits. In other implementations, the bit 110 may be a mill used for removing metal, composite, elastomer, other materials downhole, or combinations thereof. For instance, the bit 110 may be used with a whipstock to mill into casing 107 lining the wellbore 102. The bit 110 may also be a junk mill used to mill away tools, plugs, cement, other materials within the wellbore 102, or combinations thereof. Swarf or other cuttings formed by use of a mill may be lifted to the surface 111 or may be allowed to fall downhole. The bit 110 may include one or more cutting elements for degrading the earth formation 101.

The BHA 106 may further include a rotary steerable system (RSS). The RSS may include directional drilling tools that change a direction of the bit 110, and thereby the trajectory of the wellbore. At least a portion of the RSS may maintain a geostationary position relative to an absolute reference frame, such as one or more of gravity, magnetic north, or true north. Using measurements obtained with the geostationary position, the RSS may locate the bit 110, change the course of the bit 110, and direct the directional drilling tools on a projected trajectory. The RSS may steer the bit 110 in accordance with or based on a trajectory for the bit 110. For example, a trajectory may be determined for directing the bit 110 toward one or more subterranean targets such as an oil or gas reservoir.

The downhole system 100 may provide information (e.g., measurements from sensors) directly to an application programming interface (API) 202 accessible via a device 206. In some implementations, the data is sent directly to the API 202 from the downhole system 100. In some implementations, the application programming interface 202 is on a remote server in communication with the downhole system 100 using the device 206 via a network. In some implementations, the application programming interface 202 facilitates users with simulations of the downhole system 100.

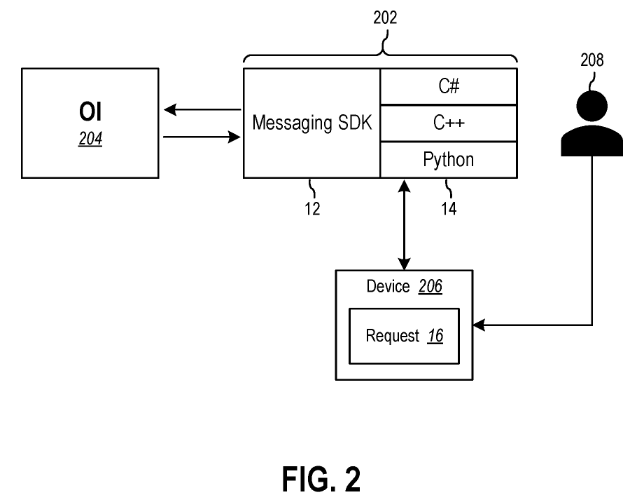

FIG. 2 illustrates an example environment 200 for an application programming interface (API) 202 enabling communications with a data engine 204. In some implementations the data engine 204 is the OLGA engine. The OLGA engine includes an OLGA simulator that is a transient multiphase flow simulator for system design and production operations. The OLGA simulator is a tool for dynamic multi-phase flow simulation and is used for networks of wells, flowlines, pipelines, and process equipment, covering the production system from bottom hole into the production system. The OLGA simulator includes a steady state pre-processor, which is intended for calculating initial values to the transient simulations and is also useful for traditional steady state parameter variations. The transient simulations of the OLGA simulator increase the range of applicability as compared to existing simulators.

In some implementations, the data engine 204 is a simulator providing a prediction of operational conditions and system dynamics, such as, time-varying changes in flow rates, fluid compositions, temperature, solids depositions, and operational changes using the data in the data engine 204. In some implementations, a device 206 is a simulator providing a prediction of operational conditions and system dynamics, such as, time-varying changes in flow rates, fluid compositions, temperature, solids depositions, and operational changes using the data in the data engine 204. In some implementations, the device 206 is a data source providing real time field data as input to the data engine 204. The API 202 is facilitating exchange of data between the device 206 and the data engine 204.

In some implementations, the data engine 204 is on a server in communication with the API 202 through a network. For example, the data engine 204 is hosted on virtual machines in the cloud. The network may include one or multiple networks and may use one or more communication platforms and/or technologies suitable for transmitting data. The network may refer to any data link that enables transport of electronic data between devices of the environment 200. The network may refer to a hardwired network, a wireless network, or a combination of a hardwired network and a wireless network. In one or more implementations, the network includes the internet. The network may be configured to facilitate communication between the various computing devices via well-site information transfer standard markup language (WITSML) or similar protocol, or any other protocol or form of communication. The server may include one or more computing devices (e.g., including processing units, data storage, etc.) organized in an architecture with various network interfaces for connecting to and providing data management and distribution across one or more client systems.

In some implementations, the user 208 accesses the API 202 using the device 206. The device 206 may be representative of one or multiple devices and may refer to various types of computing devices. For example, the device 206 may include a mobile device such as a mobile telephone, a smartphone, a personal digital assistant (PDA), a tablet, a laptop, or any other portable device. Additionally, or alternatively, the device 206 may include one or more non-mobile devices such as a desktop computer, server device, surface or downhole processor or computer (e.g., associated with a sensor, system, or function of the downhole system), or other non-portable device. In some implementations, a user interface is displayed on a display of the device 206 providing a display of information.

In some implementations, the API 202 is local to the device 206 and is accessed through an application on the device 206. In some implementations, the API 202 is on a cloud server remote from the device 206 accessed through the network. For example, a uniform resource locator (URL) configured to an end point of the API 202 is provided to the device 206 that the user 208 may access using a browser on the device 206. Another example includes an application on the device 206 of the user 208 providing access to the API 202.

In some implementations, the API 202 includes a messaging software development kit (SDK) 12 in communication with the data engine 204 and one or more applications 14. In some implementations, the applications 14 use different programming languages. For example, one application uses PYTHON, another application uses C++, and another application uses C. In some implementations, the applications 14 use the same programming languages. The messaging SDK 12 facilitates communication between the applications 14 and the data engine 204.

In some implementations, the user 208 accesses the device 206 and provides a request 16 to the API 202. In some implementations, the request 16 is for data from the data engine 204. In some implementations, the request 16 is for a simulation executed by data engine 204 using data from the data engine 204. In some implementations, the request 16 is for an interactive simulation run by the data engine 204 using data provided with the request or data in the data engine 204. In some implementations, the request 16 is to connect real-time field data (e.g., the data from downhole system 100) to the data engine 204 and perform a simulation on the real-time field data using the data engine 204. In some implementations, the request 16 is for a steady state simulation using the data engine 204. In some implementations, the request 16 is a subscription to the data engine 204 to receive updates or notifications of changes or additions of data in the data engine 204 related to the subscription.

In some implementations, the applications 14 provide the request 16 for data from the data engine 204. For example, the application 14 sends a request 16 for data from the data engine 204 to perform a simulation. Another example includes the application 14 sends a request for a simulation from the data engine 204 to use in the application 14. Another example includes the application 14 subscribing to data changes in the data engine 204 to receive data updates from the data engine 204.

The messaging SDK 12 receives the requests 16 and ensures a secure message exchange with the data engine 204. The messaging SDK 12 provides the response to the applications 14 for use with the applications 14 or for presentation on a display of the device 206. In some implementations, the messaging SDK 12 sends a message to each application 14 that subscribed to the data updates from the data engine 204 in response to data change occurring in the data related to the subscription request. The API 202 provides a fast and secure method of exchanging messages (e.g., the requests 16) from the user 208 or the applications 14 with the data engine 204.

In some implementations, the applications 14 receive the response from the data engine 204 and the applications 14 use the information in the response. For example, the applications 14 use the information in the response to perform another simulation of the reservoir or subterrain formations. In some implementations, the data engine 204 provides simulation results which are used as boundary conditions for the application 14 if the application 14 is another simulator. If the application 14 is providing real time data to the data engine 204, the data engine 204 provides simulation results used for managing field operations, e.g., cooldown advisors.

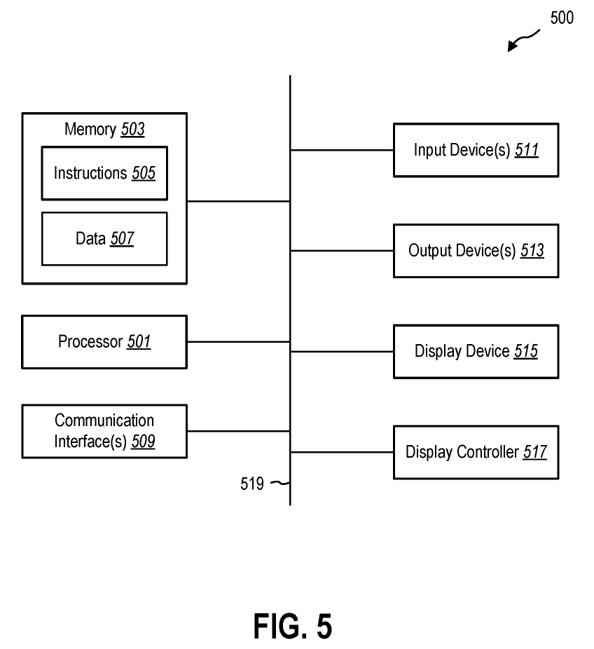

In some implementations, one or more computing devices (e.g., servers and/or devices) are used to perform the processing of the environment 200. The one or more computing devices may include, but are not limited to, server devices, cloud virtual machines, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the data engine 204 and the API 202 are implemented on a single computing device. Moreover, in some implementations, one or more subcomponents of the feature and functionalities discussed herein may be implemented and processed on different server devices of the same or different cloud computing networks. For example, the data engine 204 and the API 202 is implemented on different server devices. In this way, the environment 200 may be a cloud computing environment, and data engine 204 and the API 202 may be implemented across one or more devices of the cloud computing environment in order to leverage the processing capabilities, memory capabilities, connectivity, speed, etc., that such cloud computing environments offer in order to facilitate the features and functionalities described herein. Each of the devices of the environment 200 may include features and/or functionalities described below in connection with FIG. 5.

In some implementations, each of the components of the environment 200 is in communication with each other using any suitable communication technologies. In addition, while the components of the environment 200 are shown to be separate, any of the components or subcomponents may be combined into fewer components, such as into a single component, or divided into more components that may serve a particular implementation. In some implementations, the components of the environment 200 include hardware, software, or both. For example, the components of the environment 200 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 200 include hardware, such as a special purpose processing device to perform a certain function or group of functions. In some implementations, the components of the environment 200 include a combination of computer-executable instructions and hardware.

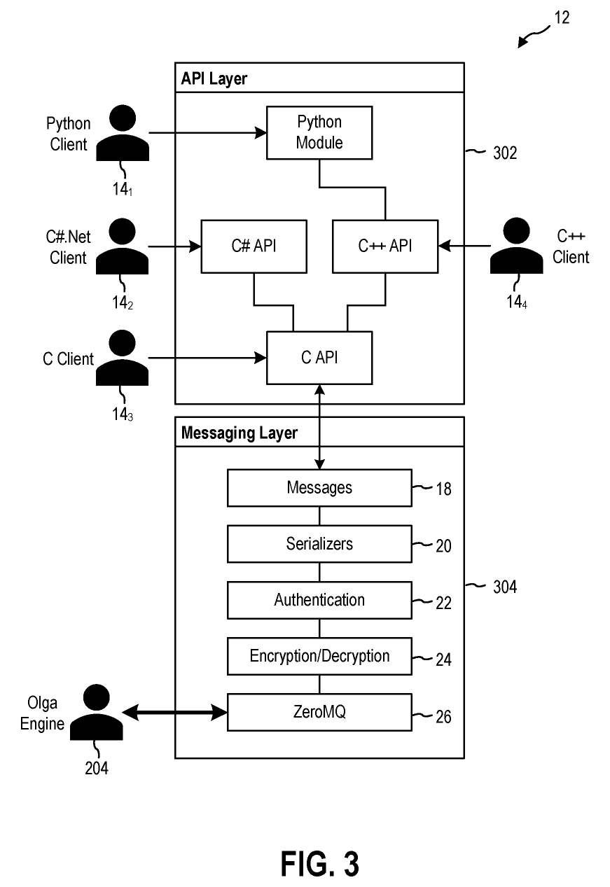

FIG. 3 illustrates an example messaging software development kit (SDK) 12. The SDK 12 includes an API layer 302 in communication with the applications 14. For example, the SDK 12 is in communication with an application 14₁ (e.g., the PHYTON application), an application 14₂ (e.g., the C# application), an application 14₃ (e.g., the C application), and an application 14₄ (e.g., the PHYTON application) through the API layer 302. It should be appreciated that any number of applications 14 may be in communication with the SDK 12. In some implementations, the applications 14 provide a request 16 (FIG. 2) to the data engine 204. In some implementations, the user 208 (FIG. 2) accesses the API layer 302 using the device 206 (FIG. 2) to provide the request 16 to the data engine 204.

The SDK 12 includes a messaging layer 304 in communication with the API layer 302 and the data engine 204. The messaging layer 304 includes a message module 18 that receives the requests 16 (FIG. 2) from the applications 14 and converts the requests 16 into messages in a format understandable by the data engine 204. In some implementations, the requests 16 are API calls that are converted into objects (e.g., the messages) in a programming language used by the messaging layer 304. The data engine 204 includes internal implementations for handling each defined message. Messages are a packet of information sent to the data engine 204. For example, the message module 18 transforms the request 16 into a message into a programming language compatible with the data engine 204. For example, if the request 16 is in a C programming language, the message module 18 transforms the request 16 from the C programming language into a format compatible with the data engine 204.

In some implementations, the messaging layer 304 is in communication with the API layer 302 through the application 14₃ (e.g., the C application) and the other applications (e.g., the application 14₁ (e.g., the PHYTON application), the application 14₂ (e.g., the C# application), and the application 14₄ (e.g., the PHYTON application) are in communication with the application 14₃ (e.g., the C application). For example, the API layer 302 first converts the request 16 from PHYTON to C++ and converts the request from C++ to C before sending the request 16 to the message module 18 in the messaging layer 304.

The message module 18 is in communication with a serializer module 20. The serializer module 20 handles message serialization and deserialization. The serializer module 20 is in communication with an authentication module 22 that handles message authentication. In some implementations, the authentication module 22 verifies the application 14 is authorized to communicate with the data engine 204. In some implementations the authentication module 22 verifies the application 14 is authorized to receive the requested data from the data engine 204. In some implementations, the authentication module 22 verifies the user 208 is authorized to communicate with the data engine 204. In some implementations the authentication module 22 verifies the user 208 is authorized to receive the requested data from the data engine 204.

The authentication module 20 is in communication with an encryption module 24 that handles message encryption and decryption. The encryption module 24 is in communication with a ZeroMQ module 26. The ZeroMQ module 26 facilitates the network communication with the data engine 204. In some implementations, the ZeroMQ module 26 uses network communication protocols to (e.g., transmission control protocol (TCP)/internet protocol (IP)) communicate with the data engine 204.

In some implementations, each request 16 is processed by each module (e.g., the message module 18, the serializer module 20, the authentication module 22, the encryption module 24, and the ZeroMQ module 26) in the messaging layer 304 before the request 16 is sent to the data engine 204. In some implementations, each response from the data engine 204 is processed by each module in the messaging layer 304 before the response is sent to the applications 14.

In some implementations, the settings for the messaging layer 304 are configurable and the request 16 or the response from the data engine 204 may be processed by a subset of modules in the messaging layer 304. For example, one user may enable encryption and authentication for communicating with the data engine 204 while a different user may enable authentication without enabling encryption for communicating with the data engine 204. Another example includes selecting different settings for communicating with the data engine 204. Another example includes providing a serialization type (e.g., binary or JSON) for the messages. Another example includes requesting logging to occur.

The SDK 12 ensures a secure message exchange with the data engine 204. In addition, the SDK 12 enables different programming languages to communicate with the data engine 204 by performing the processing in the messaging layer 304.

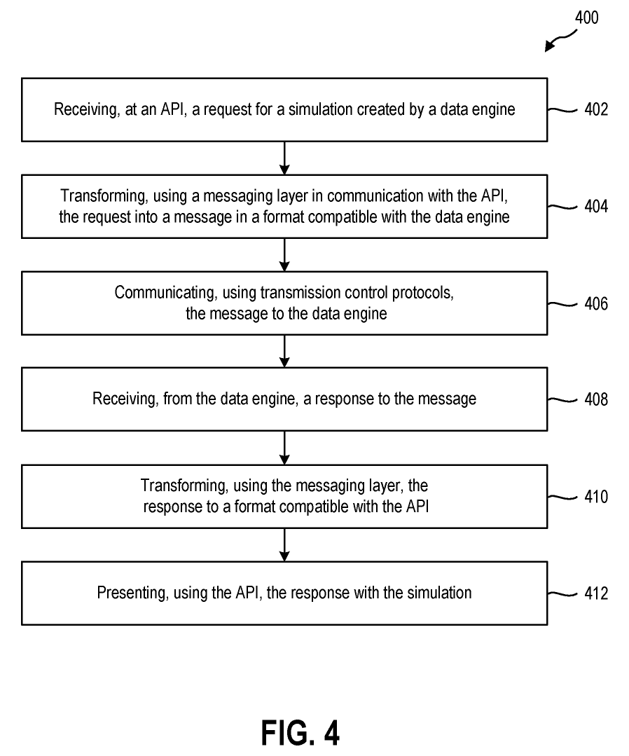

FIG. 4 illustrates an example method 400 for communicating with a data engine 204 (FIG. 2). The actions of the method 400 are discussed below in reference to FIGS. 1-3.

At 402, the method 400 includes receiving, at an API, a request for a simulation created by a data engine. The API 202 receives a request 16 for a simulation created by the data engine 204. In some implementations, the simulation is initiated by the data engine 204. In some implementations, the simulation is initiated by the device 206. In some implementations, the data engine 204 is OLGA. In some implementations, the data engine 204 is PIPESIM of Schlumberger Technologies.

In some implementations, the simulation is a steady state simulation. A steady state simulation is a type of simulation used to analyze systems where the variables remain constant over time, meaning the behavior of the system remains constant (e.g., does not change) as it operates. Steady state simulations are useful in fields, such as, chemical engineering, where understanding a performance of the system under stable conditions can simplify calculations and optimize operations.

In some implementations, the request 16 includes real-time field data from a reservoir and the simulation uses the real-time field data from the reservoir. In some implementations, the request 16 is for an operation (e.g., pause, continue, stop, save, etc.). In some implementations, the request 16 is from a user 208. In some implementations, the request 12 is received from the device 206. In some implementations, the request 16 is received from a simulator. In some implementations, the request 16 is from an application 14 performing an interactive simulation on a subterrain formation. In some implementations, the request 16 is received from other sources in communication with the data engine 204.

In some implementations, the request 16 is a subscription for notifications of changes in data in the data engine 204. One example of a change in data includes new data added to the data engine related to the subscription. Another example of a change in data includes data related to the subscription is removed from the data engine. Another example of a change in data includes updates occurred to data related to the subscription.

At 404, the method 400 includes transforming, using a messaging layer in communication with the application programming interface, the request into a message in a format compatible with the data engine. In some implementations, a messaging layer 304 in communication with the API 202 transforms the request 16 into a message in a format compatible with the data engine 204. In some implementations, the messaging layer 304 is part of an SDK 12 in communication with the API 202. In some implementations, the request 16 is from an application 14 with a programming language different from the data engine 204 and the messaging layer 304 transforms the programming language of the application 14 into a format compatible with the data engine 204.

At 406, the method 400 includes communicating, using transmission control protocols, the message to the data engine. In some implementations, the messaging layer 304 communicates with the data engine 204 using TCP/IP protocols. In some implementations, the messaging layer 304 performs authentication of the request 16 and communicates using the TCP/IP protocols the message to the data engine 204 in response to authenticating the request 16.

At 408, the method 400 includes receiving, from the data engine, a response to the message. The messaging layer 304 receives a response to the message from the data engine 204. In some implementations, the data engine 204 performs processing on data in the data engine 204 in response to the message. In some implementations, the data engine 204 retrieves data in response to the message. In some implementations, the data engine 204 performs a simulation using data in the data engine 204 in response to the message.

In some implementations, the data engine 204 automatically provides the response to a subscription upon detecting a change in data related to the subscription and the API 202 presents the response with the changes in the data.

At 410, the method 400 includes transforming, using the messaging layer, the response to a format compatible with the application programming interface. The messaging layer 304 transforms the response from the data engine 204 into a format compatible with the API 202.

At 412, the method 400 includes presenting, using the application programming interface, the response with the simulation. In some implementations, the simulation provides a prediction of operational conditions and system dynamics of a wellbore. The API 202 presents the response with the simulation. In some implementations, the API 202 displays the response on a user interface of a device 206 of a user 208.

The method 400 enables fast and secure communications with the data engine 204 using the API 202.

Turning now to FIG. 5, this figure illustrates certain components that may be included within a computer system 500. One or more computer systems 500 may be used to implement the various devices, components, and systems described herein.

The computer system 500 includes a processor 501. The processor 501 may be a general-purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 501 may be referred to as a central processing unit (CPU). Although just a single processor 501 is shown in the computer system 500 of FIG. 5, in an alternative configuration, a combination of processors (e.g., an ARM and DSP) could be used.

The computer system 500 also includes memory 503 in electronic communication with the processor 501. The memory 503 may include computer-readable storage media and can be any available media that can be accessed by a general purpose or special purpose computer system. Computer-readable media that store computer-executable instructions are non-transitory computer-readable media (device). Computer-readable media that carry computer-executable instructions are transmission media. Thus, by way of example and not limitations, implementation of the present disclosure can comprise at least two distinctly different kinds of computer-readable media: non-transitory computer-readable media (devices) and transmission media.

Both non-transitory computer-readable media (devices) and transmission media may be used temporarily to store or carry software instructions in the form of computer readable program code that allows performance of implementations of the present disclosure. Non-transitory computer-readable media may further be used to persistently or permanently store such software instructions. Examples of non-transitory computer-readable storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored or in software, hardware, firmware, or combinations thereof.

Instructions 505 and data 507 may be stored in the memory 503. The instructions 505 may be executable by the processor 501 to implement some or all of the functionality disclosed herein. Executing the instructions 505 may involve the use of the data 507 that is stored in the memory 503. Any of the various examples of modules and components described herein may be implemented, partially or wholly, as instructions 505 stored in memory 503 and executed by the processor 501. Any of the various examples of data described herein may be among the data 507 that is stored in memory 503 and used during execution of the instructions 505 by the processor 501.

A computer system 500 may also include one or more communication interfaces 509 for communicating with other electronic devices. The communication interface(s) 509 may be based on wired communication technology, wireless communication technology, or both. Some examples of communication interfaces 509 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

The communication interfaces 509 may connect the computer system 500 to a network. A “network” or “communications network” may generally be defined as one or more data links that enable the transport of electronic data between computer systems and/or modules, engines, or other electronic devices, or combinations thereof. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instruction or data structures and which can be accessed by a general purpose or special purpose computer.

A computer system 500 may also include one or more input devices 511 and one or more output devices 513. Some examples of input devices 511 include a keyboard, mouse, microphone, remote control device, button, joystick, trackball, touchpad, and lightpen. Some examples of output devices 513 include a speaker and a printer. One specific type of output device that is typically included in a computer system 500 is a display device 515. Display devices 515 used with implementations disclosed herein may utilize any suitable image projection technology, such as liquid crystal display (LCD), light-emitting diode (LED), gas plasma, electroluminescence, or the like. A display controller 517 may also be provided, for converting data 507 stored in the memory 503 into one or more of text, graphics, or moving images (as appropriate) shown on the display device 515.

The various components of the computer system 500 may be coupled together by one or more buses, which may include one or more of a power bus, a control signal bus, a status signal bus, a data bus, other similar components, or combinations thereof. For the sake of clarity, the various buses are illustrated in FIG. 5 as a bus system 519.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a clustering model, a regression model, a language model, an object detection model, a probabilistic graphical model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Further, upon reaching various computer system components, program code in the form of computer-executable instructions or data structures can be transferred automatically or manually from transmission media to non-transitory computer-readable storage media (or vice versa). For example, computer executable instructions or data structures received over a network or data link can be buffered in memory (e.g., RAM) within a network interface module (NIC), and then eventually transferred to computer system RAM and/or to less volatile non-transitory computer-readable storage media at a computer system. Thus, it should be understood that non-transitory computer-readable storage media can be included in computer system components that also (or even primarily) utilize transmission media.

### INDUSTRIAL APPLICABILITY

The following description from ¶¶ [0014]-[0069] includes various implementations that, where feasible, may be combined in any permutation. For example, the implementation of ¶¶ [0014]-[0069] may be combined with any or all implementations of the following paragraphs. Implementations that describe acts of a method may be combined with implementations that describe, for example, systems and/or devices. Any permutation of the following paragraphs is considered to be hereby disclosed for the purposes of providing “unambiguously derivable support” for any claim amendment based on the following paragraphs. Furthermore, the following paragraphs provide support such that any combination of the following paragraphs would not create an “intermediate generalization.”

In some implementations, a method includes receiving, at an application programming interface, a request for a simulation created by a data engine. The method includes transforming, using a messaging layer in communication with the application programming interface, the request into a message in a format compatible with the data engine. The method includes communicating, using transmission control protocols, the message to the data engine. The method includes receiving, from the data engine, a response to the message. The method includes transforming, using the messaging layer, the response to a format compatible with the application programming interface. The method includes presenting, using the application programming interface, the response with the simulation.

In some implementations, the method includes the request is from an application with a programming language different from the data engine and the messaging layer transforms the programming language of the application into a format compatible with the data engine.

In some implementations, the method includes the simulation is a steady state simulation.

In some implementations, the method includes the request is from an application performing an interactive simulation on a subterrain formation.

In some implementations, the method includes the request is a subscription for notifications of changes in data in the data engine.

In some implementations, the method includes automatically receiving, from the data engine, the response to the subscription upon detecting a change in data related to the subscription; and presenting, using the application programming interface, the response with the changes in data.

In some implementations, the method includes the change in data including new data added to the data engine related to the subscription, data related to the subscription is removed from the data engine, or updates occur to data related to the subscription.

In some implementations, the method includes performing, using the messaging layer, authentication of the request; and communicating, using the transmission control protocols, the message to the data engine in response to authenticating the request.

In some implementations, the method includes the request including real-time field data from a reservoir and the simulation uses the real-time field data from the reservoir.

In some implementations, the method includes the simulation providing a prediction of operational conditions and system dynamics of a wellbore.

In some implementations, the system includes a memory to store data and instructions; and a processor operable to communicate with the memory, wherein the processor is operable to: receive, at an application programming interface, a request for a simulation created by a data engine; transform, using a messaging layer in communication with the application programming interface, the request into a message in a format compatible with the data engine; communicate, using transmission control protocols, the message to the data engine; receive, from the data engine, a response to the message; transform, using the messaging layer, the response to a format compatible with the application programming interface; and present, using the application programming interface, the response with the simulation.

In some implementations, a computer-readable storage medium including instructions that, when executed by a processor, cause the processor to: receive, at an application programming interface, a request for a simulation created by a data engine; transform, using a messaging layer in communication with the application programming interface, the request into a message in a format compatible with the data engine; communicate, using transmission control protocols, the message to the data engine; receive, from the data engine, a response to the message; transform, using the messaging layer, the response to a format compatible with the application programming interface; and present, using the application programming interface, the response with the simulation.

One or more specific implementations of the present disclosure are described herein. These described implementations are examples of the presently disclosed techniques. Additionally, in an effort to provide a concise description of these implementations, not all features of an actual implementation may be described in the specification. It should be appreciated that in the development of any such actual implementation, as in any engineering or design project, numerous implementation-specific decisions will be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. There is no intention to invoke means-plus-function or other functional claiming for any claim except for those in which the words ‘means for’ appear together with an associated function. Each addition, deletion, and modification to the implementations that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements. Additionally, as used herein, the term “and/or” includes any and all combinations of one or more of the associated listed items.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
receiving, at an application programming interface, a request for a simulation created by a data engine;
transforming, using a messaging layer in communication with the application programming interface, the request into a message in a format compatible with the data engine;
communicating, using transmission control protocols, the message to the data engine;
receiving, from the data engine, a response to the message;
transforming, using the messaging layer, the response to a format compatible with the application programming interface; and
presenting, using the application programming interface, the response with the simulation.

2. The method of claim 1, wherein the request is from an application with a programming language different from the data engine and the messaging layer transforms the programming language of the application into a format compatible with the data engine.

3. The method of claim 1, wherein the simulation is a steady state simulation.

4. The method of claim 1, wherein the request is from an application performing an interactive simulation on a subterrain formation.

5. The method of claim 1, wherein the request is a subscription for notifications of changes in data in the data engine.

6. The method of claim 5, further comprising:
automatically receiving, from the data engine, the response to the subscription upon detecting a change in data related to the subscription; and
presenting, using the application programming interface, the response with the changes in data.

7. The method of claim 6, wherein a change in data includes new data added to the data engine related to the subscription, data related to the subscription is removed from the data engine, or updates occur to data related to the subscription.

8. The method of claim 1, further comprising:
performing, using the messaging layer, authentication of the request; and
communicating, using the transmission control protocols, the message to the data engine in response to authenticating the request.

9. The method of claim 1, wherein the request includes real-time field data from a reservoir and the simulation uses the real-time field data from the reservoir.

10. The method of claim 1, wherein the simulation provides a prediction of operational conditions and system dynamics of a wellbore.

11. A system, comprising:
a memory to store data and instructions; and
a processor operable to communicate with the memory, wherein the processor is operable to:
receive, at an application programming interface, a request for a simulation created by a data engine;
transform, using a messaging layer in communication with the application programming interface, the request into a message in a format compatible with the data engine;
communicate, using transmission control protocols, the message to the data engine;
receive, from the data engine, a response to the message;
transform, using the messaging layer, the response to a format compatible with the application programming interface; and
present, using the application programming interface, the response with the simulation.

12. The system of claim 11, wherein the request is from an application with a programming language different from the data engine and the messaging layer transforms the programming language of the application into a format compatible with the data engine.

13. The system of claim 11, wherein the simulation is a steady state simulation.

14. The system of claim 11, wherein the request is from an application performing an interactive simulation on a subterrain formation.

15. The system of claim 11, wherein the request is a subscription for notifications of changes in data in the data engine.

16. The system of claim 15, wherein the processor is further operable to:
automatically receive, from the data engine, the response to the subscription upon detecting a change in data related to the subscription; and
present, using the application programming interface, the response with the changes in data.

17. The system of claim 11, wherein a change in data includes new data added to the data engine related to the subscription, data related to the subscription is removed from the data engine, or updates occur to data related to the subscription.

18. The system of claim 11, wherein the processor is further operable to:
perform, using the messaging layer, authentication of the request; and
communicate, using the transmission control protocols, the message to the data engine in response to authenticating the request.

19. The system of claim 11, wherein the request includes real-time field data from a reservoir and the simulation uses the real-time field data from the reservoir.

20. The system of claim 11, wherein the simulation provides a prediction of operational conditions and system dynamics of a wellbore.
